(19) United States
(12) Patent Application Publication
(10) Pub. No.: US 2022/0066245 A1
(43) Pub. Date: Mar. 3, 2022

(54) LIGHT MODULATION DEVICE

(71) Applicant: ELECTRONICS AND TELECOMMUNICATIONS RESEARCH INSTITUTE, Daejeon (KR)

(72) Inventors: Kap-Joong KIM, Daejeon (KR); Chun Ju YOUN, Daejeon (KR); Young-Ho KO, Daejeon (KR); Minchul KIM, Daejeon (KR); Kyongchun LIM, Daejeon (KR); Byung-Seok CHOI, Sejong-si (KR); Joong-Seon CHOE, Daejeon (KR)

(73) Assignee: ELECTRONICS AND TELECOMMUNICATIONS RESEARCH INSTITUTE, Daejeon (KR)

(21) Appl. No.: 17/464,470

(22) Filed: Sep. 1, 2021

(30) Foreign Application Priority Data
Sep. 2, 2020 (KR) 10-2020-0111807

(51) Int. Cl. G02F 1/035; G02F 1/01

(52) U.S. Cl. CPC G02F 1/035; G02F 2202/32; G02F 2201/06; G02F 1/0136

(57) ABSTRACT

Provided is a light modulation device includes a substrate, a lower clad layer disposed on the substrate, a core layer disposed on the lower clad layer to extend in a first direction which is parallel to a top surface of the substrate, and an upper clad layer covering the core on the lower clad layer. The core layer includes a waveguide layer extending in the first direction; and photonic crystal structures disposed in the waveguide layer and periodically arranged along the first direction.

### CROSS-REFERENCE TO RELATED APPLICATIONS

This U.S. non-provisional patent application claims priority under 35 U.S.C. § 119 of Korean Patent Application No. 10-2020-0111807, filed on Sep. 2, 2020, the entire contents of which are hereby incorporated by reference.

### BACKGROUND

The present disclosure herein relates to a light modulation device, and more particularly, to a light modulation device that is capable of forming a multiple polarization state.

Recently, as high-speed Internet and various multimedia services emerge, various technologies for providing massive information have been developed. Particularly, various optical devices for information transmission are being developed, and various types of optical devices are being used in the optical communication fields and in various fields due to the development of fabrication processes. However, due to the increase in a large piece of information to be transmitted, technologies that modulate not only light intensity but also polarization so as to be transmitted as a signal has to be practically used for optical communication. In addition, since technologies using polarization modulation is being used for quantum key distribution for secure data communication. For this, there is a demand for optical modulation devices that form various polarization states.

### SUMMARY

The present disclosure provides a light modulation device that provides a plurality of polarization states.

The present disclosure also provides a light modulation device having a small size.

The object of the present disclosure is not limited to the aforesaid, but other objects not described herein will be clearly understood by those skilled in the art from descriptions below.

An embodiment of the inventive concept provides a light modulation device includes: a substrate; a lower clad layer disposed on the substrate; a core layer disposed on the lower clad layer to extend in a first direction which is parallel to a top surface of the substrate; and an upper clad layer covering the core on the lower clad layer. The core layer may include: a waveguide layer extending in the first direction; and photonic crystal structures disposed in the waveguide layer and periodically arranged along the first direction.

In an embodiment, each of the photonic crystal structures may include a hole vertically penetrating the waveguide layer.

In an embodiment, the photonic crystal structures may include photonic crystal patterns. The photonic crystal patterns may include a material having a reflective index same as that of the waveguide layer or a material having a refractive index different from that of the waveguide layer.

In an embodiment, the core layer may have birefringence property in second and third directions that are perpendicular to each other, wherein each of the second and third direction is perpendicular to the first direction.

In an embodiment, the light modulation device may further include a heater or modulating electrode on the upper clad layer.

In an embodiment, a refractive index of the core layer, refractive indexes of the lower clad layer and the upper clad layer, or refractive indexes of the core layer, the lower clad layer, and the upper clad layer may vary by applying an electrical signal to the heater or the modulating electrode.

In an embodiment of the inventive concept, a light modulation device includes: a waveguide layer buried in a clad layer and extending in a first direction; photonic crystal structures disposed in the waveguide layer; and a heater or electrode disposed on a top surface of the clad layer on the waveguide layer. The photonic crystal structures may have a reflective index same as that of the waveguide layer or have a refractive index different from that of the waveguide layer. The waveguide layer may have birefringence property in second and third directions that are perpendicular to each other, wherein each of the second and third directions is perpendicular to the first direction.

In an embodiment, the photonic crystal structures may be periodically arranged along the first direction.

In an embodiment, a refractive index of the core layer, a refractive index of the clad layer, or refractive indexes of the core layer and the clad layer may vary by applying an electrical signal to the heater or the electrode.

In an embodiment, each of the photonic crystal structures may include a hole vertically penetrating the waveguide layer.

In an embodiment, the photonic crystal structures may include photonic crystal patterns. The photonic crystal patterns may include a material having a reflective index same as that of the waveguide layer or a material having a refractive index different from that of the waveguide layer.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view for explaining a light modulation device according to embodiments of the inventive concept;

FIG. 2 is a cross-sectional view for explaining the light modulation device according to embodiments of the inventive concept;

FIG. 3 is a cross-sectional view for explaining the light modulation device and a polarization state of incident light according to embodiments of the inventive concept;

FIG. 4 is a graph for explaining the incident light;

FIG. 5 is a graph for explaining light modulation; and

FIGS. 6 to 9 are graphs for explaining output light.

### DETAILED DESCRIPTION

Embodiments of the inventive concept will be described with reference to the accompanying drawings so as to sufficiently understand constitutions and effects of the inventive concept. The present disclosure may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. A person with ordinary skill in the technical field of the present invention pertains will be understood that the present invention can be carried out under any appropriate environments.

In the following description, the technical terms are used only for explaining a specific exemplary embodiment while not limiting the present invention. In this specification, the terms of a singular form may include plural forms unless specifically mentioned. As used in this specification, the meaning of ‘comprises’ and/or ‘comprising’ specifies a component, a step, an operation and/or an element does not exclude other components, steps, operations and/or elements.

In the specification, it will be understood that when a layer (or film) is referred to as being ‘on’ another layer or substrate, it can be directly on the other layer or substrate, or intervening layers may also be present.

Also, though terms like a first, a second, and a third are used to describe various regions and layers (or films) in various embodiments of the inventive concept, the regions and the layers are not limited to these terms. These terms are used only to discriminate one region or layer (or film) from another region or layer (or film). Therefore, a layer referred to as a first layer in one embodiment can be referred to as a second layer in another embodiment. An embodiment described and exemplified herein includes a complementary embodiment thereof. Throughout the specification, like reference numerals in the drawings denote like elements.

Unless terms used in embodiments of the present invention are differently defined, the terms may be construed as meanings that are commonly known to a person skilled in the art.

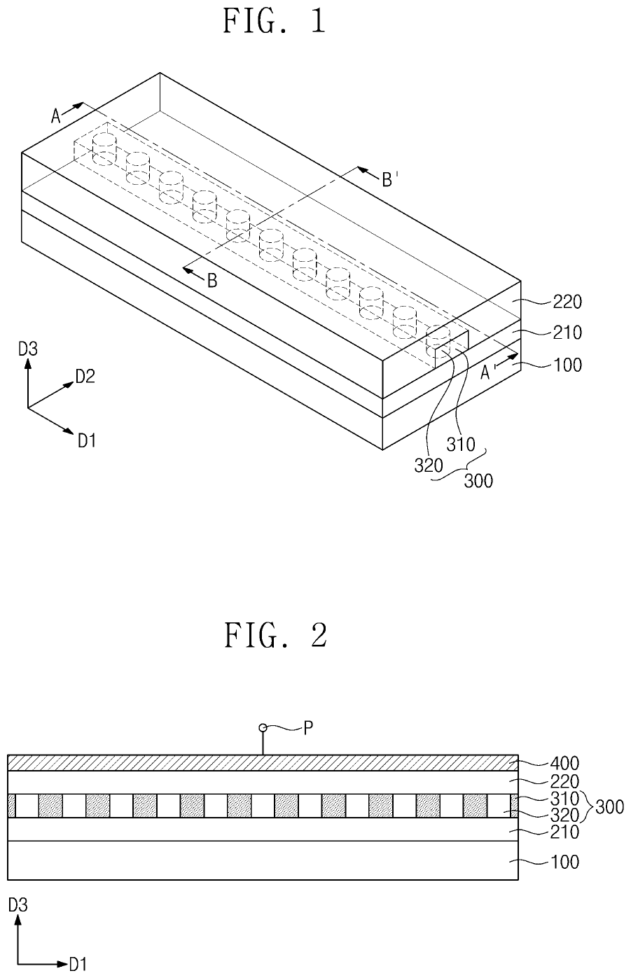

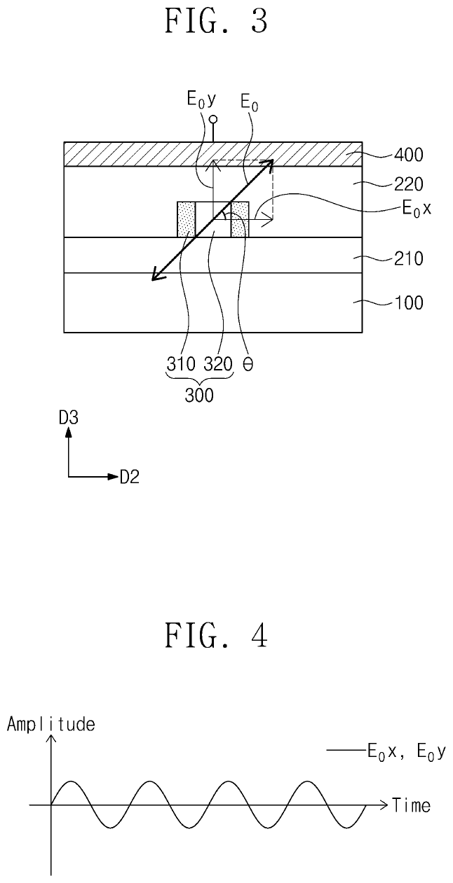

Hereinafter, a light modulation device according to an embodiment of the inventive concept will be described with reference to the accompanying drawings. FIG. 1 is a perspective view for explaining a light modulation device according to embodiments of the inventive concept. FIG. 2 is a cross-sectional view for explaining the light modulation device according to embodiments of the inventive concept, i.e., a cross-sectional view taken along line A-A′ of FIG. 1. FIG. 3 is a cross-sectional view for explaining the light modulation device and a polarization state of incident light according to embodiments of the inventive concept, i.e., a cross-sectional view taken along line B-B′ of FIG. 1.

Referring to FIGS. 1 to 3, a substrate 100 may be provided. The substrate 100 may be an insulating substrate. Alternatively, the substrate 100 may include a semiconductor substrate. Here, the semiconductor substrate may have a first conductive type. The first conductive type may be an n-type. According to an embodiment of the inventive concept, a material contained in the substrate 100 is not limited thereto, and the substrate 100 may include a substrate made of various materials as necessary. The substrate 100 may not be provided as necessary.

Hereinafter, in the specification, components of the light modulation device will be described based on a first direction D1 and a second direction D2, which are parallel to a top surface of the substrate 100, and a third direction D3 perpendicular to the top surface of the substrate 100.

A lower clad layer 210 may be disposed on the substrate 100. The lower clad layer 210 may cover the top surface of the substrate 100. The lower clad layer 210 may include an insulating material. Alternatively, the lower clad layer 210 may include a semiconductor material. Here, the semiconductor material may have a first conductive type. For example, the first conductive type may be an n-type. However, the embodiment of the inventive concept is not limited thereto, and the lower clad layer 210 may include various materials used as a cladding material.

A core layer 300 may be disposed on the lower clad layer 210. The core layer 300 may have a line shape extending in the first direction D1. The core layer 300 may have a waveguide layer 310 and photonic crystal structures 320. The core layer 300 may have various lengths according to a wavelength of light to be used in the optical modulation device or materials of the lower clad layer 210, the core layer 300, and an upper clad layer 220 to be described later.

The waveguide layer 310 may be disposed on a top surface of the lower clad layer 210. The waveguide layer 310 may have a line shape extending in the first direction D1. The waveguide layer 310 may have a refractive index greater than that of each of the lower clad layer 210 and the upper clad layer 220 to be described later. The waveguide layer 310 may include an insulating material. Alternatively, the waveguide layer 310 may include a semiconductor material. Here, the semiconductor material may have an insulation type or a first conductive type and a second conductive type, which are divided at a predetermined ratio. The first conductive type may be an n-type, and the second conductive type may be a p-type. However, the material forming the waveguide layer 310 in the embodiment of the inventive concept is not limited thereto, and the waveguide layer 310 may include various materials as necessary.

The photonic crystal structures 320 may be disposed in the waveguide layer 310. The photonic crystal structures 320 may be disposed to be perpendicular in the waveguide layer 310. Although the photonic crystal structures 320 vertically penetrates through the waveguide layer 310 in FIGS. 1 and 2, the embodiment of the inventive concept is not limited thereto. The photonic crystal structures 320 may not penetrates through the waveguide layer 310. The photonic crystal structures 320 may be periodically arranged in the waveguide layer 310 along the first direction D1. Thus, the core layer 300 may constitute a photonic crystal. Specifically, the photonic crystal has an optical structure in which materials having different shapes or different refractive indexes are arranged periodically in one direction or in several directions. The core layer 300 may have birefringence property according to the shape of the waveguide layer 310, the shape of each of the photonic crystal structures 320, or material properties of the waveguide layer 210 and each of the photonic crystal structures 320. In detail, the core layer 300 may have different refractive indexes in light of a component in the second direction D2 and light of a component in the third direction D3 with respect to light traveling in the first direction D1. For example, a traveling speed of the light having a component in the second direction D2 with respect to the light traveling in the first direction D1 within the core layer 300 may be less than that of the light having a component of the third direction D3. The photonic crystal structures 320 may have a refractive index same as the waveguide layer 310 or may have a refractive index different from that of the waveguide layer 310. According to embodiments, each of the photonic crystal structures 320 may be a hole defined to be perpendicular to the waveguide layer 310. The photonic crystal structures 320 may include a material having a refractive index same as a refractive index of the waveguide layer 310 or may include a material having a refractive index different from the refractive index of the waveguide layer 310.

The upper clad layer 220 may be disposed on the lower clad layer 210. The upper clad layer 220 may cover the core layer 300 on a top surface of the lower clad layer 210. That is, the core layer 300 may be buried by the lower clad layer 210 and the upper clad layer 220. The upper clad layer 220 may include an insulating material. Alternatively, the upper clad layer 220 may include a semiconductor material. Here, the semiconductor material may have a second conductive type. For example, the second conductive type may be a p-type. However, the embodiment of the inventive concept is not limited thereto, and the upper clad layer 220 may include various materials used as a cladding material.

The electrode 400 may be disposed on the upper clad layer 220. The electrode 400 may cover at least a portion of a top surface of the upper clad layer 220. The electrode 400 may apply an electrical signal or heat to the core layer 300, the lower clad layer 210, and the upper clad layer 220. Although the electrode 400 provided as a single layer is illustrated in FIGS. 2 and 3, the embodiment of the inventive concept is not limited thereto. Refractive indexes of the core layer 300, the upper clad layer 220, and the lower clad layer 210 may be modulated by the electrode 400. In some embodiments, by applying the electrical signal or the heat to the electrode 400, a first refractive index of the core layer 300 may vary and second refractive indexes of the upper clad layer 220 and the lower clad layer 210 may not vary. In other embodiments, by applying the electrical signal or the heat to the electrode 400, the first refractive index of the core layer 300 may not vary and the second refractive indexes of the upper clad layer 220 and the lower clad layer 210 may vary. Alternatively, by applying the electrical signal or the heat to the electrode 400, both of the first refractive index of the core layer 300 and the second refractive indexes of the upper clad layer 220 and the lower clad layer 210 may vary. Accordingly, light passing through the core layer 300 may be modulated through the electric signal or the heat applied to the electrode 400.

FIG. 4 is a graph for explaining the incident light.

The optical modulation device may modulate information with respect to polarization of input light. Particularly, the optical modulation device may modulate light passing through the core layer 300 through an electric signal applied to the electrode 400.

As illustrated in FIG. 3, incident light may be incident from one end of the optical modulation device to travel in the first direction D1 through the core layer 300. That is, the traveling direction of the incident light may be the first direction D1, and polarization of the incident light may be located on a plane parallel to the second direction D2 and the third direction D3.

The polarization E0 of the incident light may be diagonal polarization. The polarization E0 of the incident light may be divided into an X component E0x in the second direction D2 and a Y component E0y in the third direction D3. When the polarization E0 of the incident light is the diagonal polarization, as illustrated in FIG. 4, the X component E0x and the Y component E0y may have the same phase. That is, a phase difference between the X component E0x and the Y component E0y may be 0. In this case, when amplitudes of the X component E0x and the Y component E0y are the same as illustrated in FIG. 4, the polarization E0 may be diagonal polarization in which an angle θ is about 45° as illustrated in FIG. 3. Preferably, the angle θ may be 45°, but the angle θ may include some error value.

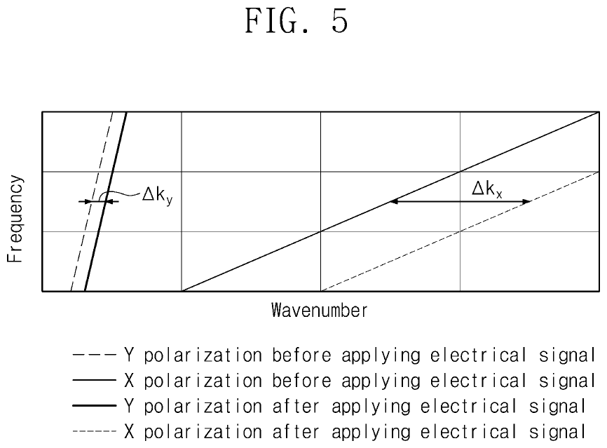

The core layer 300 may have birefringence property according to the shape of the waveguide layer 310, the shape of each of the photonic crystal structures 320, or material properties of the waveguide layer 210 and each of the photonic crystal structures 320. FIG. 5 is a graph for explaining the light modulation. Referring to FIG. 5, when an electric signal is applied to the electrode 400, the incident light traveling in the first direction D1 within the core layer 300 may have different wavenumbers depending on the components. Here, a component of the traveling light, which has a slow group velocity may have a large wavenumber change. According to embodiments of the inventive concept, a group velocity of the X component E₀ₓ in the second direction D2 of the light traveling in the first direction D1 within the core layer 300 may be less than that of the Y component E_{0y} in the third direction D3. Thus, when the electric signal is applied to the electrode 400, a wavenumber change Δkₓ of the X component E₀ₓ of the incident light may be relatively large, and a wavenumber change Δk_{y} of the Y component E_{0y} of the incident light may be relatively small. That is, since degrees to which the X component E₀ₓ and the Y component E_{0y} of the incident light are shifted from each other are different from each other according to the intensity of the applied electric signal, polarization of output light may be modulated. According to embodiments of the inventive concept, as illustrated in FIG. 5, when the electrical signal is not applied to the electrode 400 using the photonic crystal, since a difference between the wavenumbers of the X component Eₐₓ and the Y component E_{ay} is made very large, a beat length that is a minimum length having the same polarization as the incident light may be made very short. Since a difference between a group velocity of the X component Eₐₓ and a group velocity of the Y component E_{ay} of the light traveling through the optical modulation device is made very large, a difference Δk_{y}−Δkₓ in wavelength change Δkₓ between an X component Eₐₓ of the light traveling through the optical modulation device when the electrical signal is not applied to the electrode 400 and an X component E_{bx} of the light traveling through the optical modulation device when the electrical signal is applied to the electrode 400 and a wavelength change Δk_{y} between a Y component E_{ay} of the light traveling through the optical modulation device when the electric signal is not applied to the electrode 400 and a Y component E_{by} of the light traveling through the optical modulation device when the electric signal is applied to the electrode 400 may be made very large. Here, even with a small change in the applied electrical signal, the shift of the X component E₀ₓ and the Y component E_{0y} of the incident light may be made large. That is, a phase difference between an X component Eₙₓ and a Y component E_{ny} of the output light having a desired intensity is generated with the small change in the applied electric signal, a low power and small optical modulation device may be implemented.

According to embodiments of the inventive concept, output light having four polarization states may be generated according to a change in wavenumber of the X component E₀ₓ and the Y component E_{0y} of the incident light.

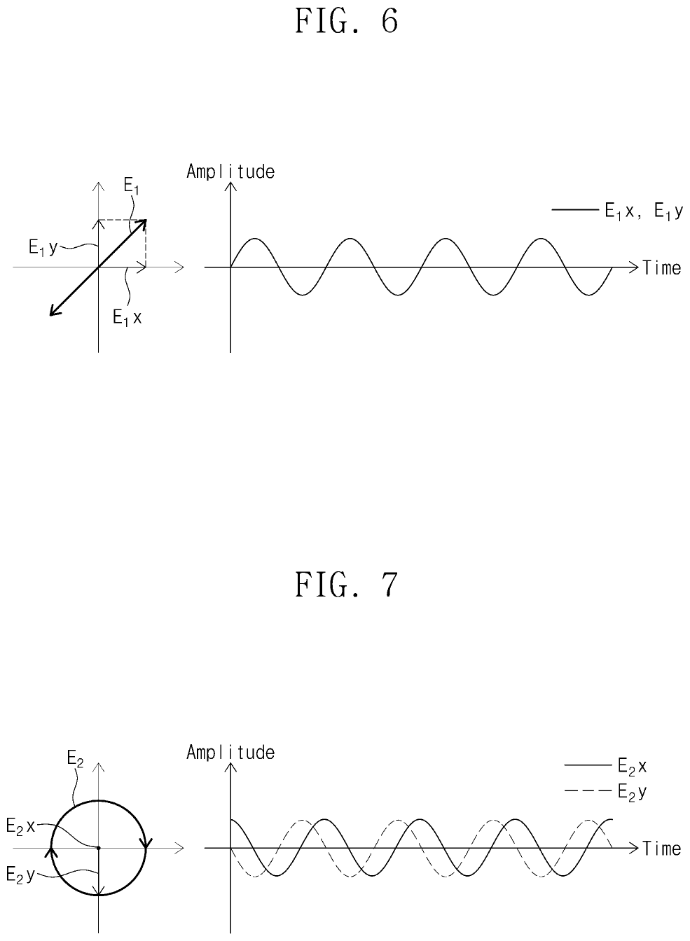

FIGS. 6 to 9 are graphs for explaining modulated light, i.e., illustrate waveforms of output light when electrical signals having different intensities are applied to the electrode.

As illustrated in FIG. 6, the X component E₀ₓ and the Y component E_{0y} of the incident light may be shifted from each other, and an X component E₁ₓ and a Y component E_{1y} of polarization E₁ of first output light may have a phase difference of about 0°. That is, the first output light may be diagonal polarization that is oriented at an angle of about 45°.

As illustrated in FIG. 7, the X component E₀ₓ and the Y component E_{0y} of the incident light may be shifted from each other, and an X component E₂ₓ and a Y component E_{1y} of polarization E₂ of second output light may have a phase difference of about 90°. That is, the second output light may be right-circular polarization (RCP).

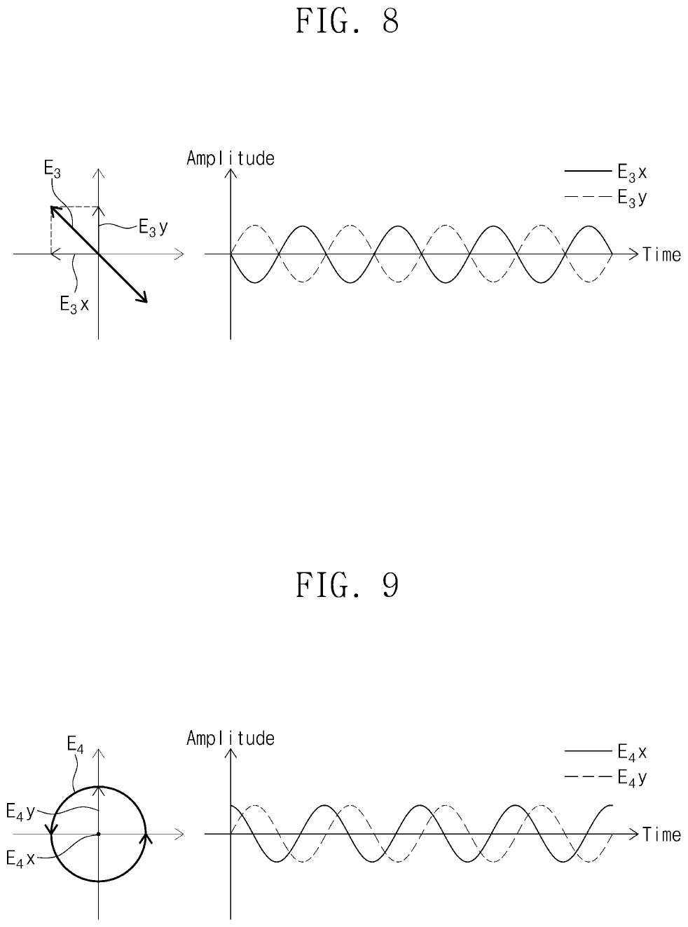

As illustrated in FIG. 8, the X component E₀ₓ and the Y component E_{0y} of the incident light may be shifted from each other, and an X component E₃ₓ and a Y component E_{3y} of polarization E₃ of third output light may have a phase difference of about 180°. That is, the third output light may be anti-diagonal polarization that is oriented at an angle of about −45°.

As illustrated in FIG. 9, the X component E₀ₓ and the Y component E_{0y} of the incident light may be shifted from each other, and an X component E₄ₓ and a Y component E_{4y} of polarization E₄ of fourth output light may have a phase difference of about 270°. That is, the fourth output light may be left-circular polarization (LCP).

Although each of the phase difference of the four polarization states is 0°, 90°, 180° and 270° in FIGS. 6 and 9, the embodiment of the inventive concept is not limited thereto, each of the four polarization states may have the phase difference that may be distinguished from each other, or the phase difference may include some error value.

As illustrated in FIGS. 6 to 9, the light modulation device according to embodiments of the inventive concept may modulate the incident light to have the four polarization states such as the diagonal polarization that is oriented at the angle of about 45°, the left-circular polarization (LCP), the anti-diagonal polarization that is oriented at the angle of about −45°, and the right-circular polarization (RCP) according to the shift of the X component E₀ₓ and the Y component E_{0y} of incident light. Here, in some case, other polarization states may be implemented.

In addition, the incident light may be modulated into the plurality of polarization states to use the electrode, the core layer, the lower clad layer, and the upper clad layer. Therefore, the additional components for the multiple modulation may not be required, and also, the low power and small light modulation device may be implemented.

The light modulation device according to the embodiments of the inventive concept may modulate the incident light into the four polarization states according to the shift of the X component and the Y component of the incident light.

In addition, the incident light may be modulated into the plurality of polarization states to use the electrode, the core layer, the lower clad layer, and the upper clad layer. Therefore, the additional components for the multiple modulation may not be required, and thus, the size of the light modulation device may be small.

Although the embodiment of the inventive concept is described with reference to the accompanying drawings, those with ordinary skill in the technical field of the inventive concept pertains will be understood that the present disclosure can be carried out in other specific forms without changing the technical idea or essential features. Therefore, the above-disclosed embodiments are to be considered illustrative and not restrictive.

What is claimed is:

1. A light modulation device comprising:
a substrate;
a lower clad layer disposed on the substrate;
a core layer disposed on the lower clad layer to extend in a first direction which is parallel to a top surface of the substrate; and
an upper clad layer covering the core on the lower clad layer,
wherein the core layer comprises:
a waveguide layer extending in the first direction; and
photonic crystal structures disposed in the waveguide layer and periodically arranged along the first direction.

2. The light modulation device of claim 1, wherein each of the photonic crystal structures comprises a hole vertically penetrating the waveguide layer.

3. The light modulation device of claim 1, wherein the photonic crystal structures comprise photonic crystal patterns,
wherein the photonic crystal patterns comprise a material having a reflective index same as that of the waveguide layer or a material having a refractive index different from that of the waveguide layer.

4. The light modulation device of claim 1, wherein the core layer has birefringence property in second and third directions that are perpendicular to each other, wherein each of the second and third direction is perpendicular to the first direction.

5. The light modulation device of claim 1, further comprising a heater or modulating electrode on the upper clad layer.

6. The light modulation device of claim 5, wherein a refractive index of the core layer, refractive indexes of the lower clad layer and the upper clad layer, or refractive indexes of the core layer, the lower clad layer, and the upper clad layer varies by applying an electrical signal to the heater or the modulating electrode.

7. A light modulation device comprising:
a waveguide layer buried in a clad layer and extending in a first direction;
photonic crystal structures disposed in the waveguide layer; and
a heater or electrode disposed on a top surface of the clad layer on the waveguide layer,
wherein the photonic crystal structures have a reflective index same as that of the waveguide layer or have a refractive index different from that of the waveguide layer, and
the waveguide layer has birefringence property in second and third directions that are perpendicular to each other, wherein each of the second and third directions is perpendicular to the first direction.

8. The light modulation device of claim 7, wherein the photonic crystal structures are periodically arranged along the first direction.

9. The light modulation device of claim 7, wherein a first refractive index of the core layer varies and a second refractive index of the clad layer does not vary, by applying an electrical signal to the heater or the electrode.

10. The light modulation device of claim 7, wherein a first refractive index of the core layer does not vary and a second refractive index of the clad layer varies by applying an electrical signal to the heater or the electrode.

11. The light modulation device of claim 7, wherein both of a first refractive index of the core layer and a second refractive index of the clad layer vary by applying an electrical signal to the heater or the electrode.

12. The light modulation device of claim 7, wherein each of the photonic crystal structures comprises a hole vertically penetrating the waveguide layer.

13. The light modulation device of claim 7, wherein the photonic crystal structures comprise photonic crystal patterns,
wherein the photonic crystal patterns comprise a material having a reflective index same as that of the waveguide layer or a material having a refractive index different from that of the waveguide layer.
